(19) United States
(12) Patent Application Publication
(10) Pub. No.: US 2006/0137415 A1
(43) Pub. Date: Jun. 29, 2006

(54) Double cylinder lock

(76) Inventor: Donald Malcolm Fullard, WEST MIDLANDS (GB)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 10/544,777

(22) PCT Filed: Feb. 6, 2004
(86) PCT No.: PCT/GB04/00475

§ 371 Date: Oct. 14, 2005

(30) Foreign Application Priority Data
Feb. 6, 2003 (GB) 0302717.4

(51) Int. Cl. E05B 9/04

(52) U.S. Cl. 70/373

(57) ABSTRACT

A double cylinder lock (1) is provided whose cylinder (2) is provided with a flange (6). The flange (6) is located part way along the cylinder (2) and has a first, inner face (61) whose periphery is adapted to fit flush against a door or other closure, and may have a second tapered outer face (63).

This invention relates to double cylinder locks, and in particular to such cylinder locks as are designed to be fitted into a door or other closure in such a way that the cylinder projects outwardly from one or both faces of the closure.

The invention is especially concerned with the security of Euro-cylinder locks, which have a substantially uniform keyhole shaped cross section and with locks having a substantially uniform oval cross section such as are commonly used for securing domestic and other doors. The doors may be made of plastics, for example UPVC, timber, metal or other materials.

Such double cylinder locks are typically designed so that the lock cylinder projects from the door or door furniture, by as much as 10 or 15 mm on one or both sides of the door. It is not practical to reduce the total length of the cylinder, because it must be long enough to accommodate the required number of locking pins, again for security reasons. This projection represents a security risk because of the possibility of attacking the projection with any of a variety of tools to break the lock and open the door. The lock typically comprises two cylindrical portions separated by a central gap. A fixing hole is usually provided at this central part of the lock for a fixing screw for attaching the lock to the door. This fixing hole represents a security risk because it increases the likelihood of the lock breaking at its central portion if subjected to rotational or translational forces by a variety of tools.

It is an object of this invention to reduce this risk and make it more difficult successfully to attack the projecting lock cylinder.

According to this invention there is provided a double cylinder lock comprising a first lock cylinder integrally joined to a second lock cylinder, apertures for receiving locking pins being located on a surface of the first lock cylinder and a flange located part way along the first lock cylinder, said flange having a first, inner face whose periphery is adapted to fit flush against a door or door furniture, or other closure.

It will be appreciated that the flange should be located at the high risk side, usually the outdoor side of the door or other closure.

The invention extends to a door or other closure provided with a double cylinder lock comprising a first lock cylinder integrally joined to a second lock cylinder, apertures for receiving locking pins being located on a surface of the first lock cylinder, a flange located part way along the first lock cylinder, said flange having a first, inner face whose periphery is adapted to fit flush against a door or door furniture, or other closure.

The flange fits flush to the door or door furniture, or other closure, to increase the difficulty of inserting a chisel or other lever behind the flange to prise the lock out of the door or closure. It may of course fit flush within a recess provided in the door or door furniture, or other closure. The flange also serves to locate the lock in a desired position relative to the door, rendering a central fixing hole unnecessary.

The first and second portions may be cylindrical in shape, or have a key shape comprising a cylinder with a base extending down from it—such a profile is known as a Euro-cylinder, and the invention is intended to encompass locks of this shape.

The flange may extend around part, but not all, of the first lock cylinder portion. By this we may mean that, where the double cylinder lock has a major axis which connects the two lock cylinders, the flange extends in a plane generally orthogonal to this axis, the flange does not go all the way round the axis in that plane. Preferably the pin apertures are located along a lower surface of the first lock cylinder and the flange does not extend around the lower surface. The flange preferably comprises a second, outer face which is tapered. The tapering flange reduces the length of the projecting lock cylinder which is available for gripping, for example by a tool of the Mole™ wrench type, and also makes it more difficult to execute a square and effective hammer blow, and it is accordingly, for the same projection from the door or other closure, more difficult to carry out a successful attack on such a lock.

The flange may be separate from the lock cylinder. In that case the lock cylinder may be manufactured by extrusion. Such a separate flange may be secured to the cylinder by pins or otherwise, for example by soldering. The flange may simply be secured between a protrusion on the cylinder and the door or door furniture or other closure. Such a protrusion may be formed by a stud attached to the cylinder.

In other preferred embodiments of the invention, the flange is integral with the lock cylinder. Such a lock cylinder may be formed by investment casting.

The lock is preferably operable from indoor and outdoor sides of the door or closure.

It is envisaged that both lock cylinders of the lock could be operated by key, or that the indoor side cylinder could be thumb-turn operated. Since it is envisaged that the double cylinder lock would be inserted through the door or other closure from the outside, any thumb-turn knob would have to be fitted after the lock had been fitted to the door or closure, unless it was made small enough and arranged so that it could be fed through the hole in the door or closure provided for the lock.

In preferred embodiments of the invention, a removable flange may be provided on the indoor side of the cylinder for securing it in the door or closure. Such a removable flange may be secured by grub screws or the like, and a recess such as a slot may be provided in the cylinder to receive the tips of such grub screws. The lock will then be fixed in place as the fixed outer and removable inner flanges sandwich the door or other closure.

When the lock is operable from outdoor and indoor sides of the door or closure, the separately actuable first and second lock cylinders may be connected, in a known manner, through a cam to a bolt for locking and releasing the bolt upon actuation of one or other of the lock cylinders, the cam being located between the cylinders in a gap in a body of the lock housing the cylinders and which receives the lock pins. In an operative position the cam may be fully contained in the gap within the profile of the cross-section of the body. Alternatively, in its operative position the cam may be arranged to project out of the gap by a few degrees to one side or the other of the body, i.e. to what is commonly called a “twenty-five past” or “twenty-five to” position. In this alternative arrangement the cam may act with the integral, or fixed, flange to retain the lock securely in the door. A fixing bolt or screw may not then be necessary for securing the lock in the door or closure.

The adoption of the present invention also allows the length of the cylinder lock to be increased while maintaining an acceptably low level of risk of successful attack. Typically such a lock contains five locking pins for positioning by the key to unlock the door or other closure to which it is fitted. A greater degree of security against picking of the lock is afforded by using six locking pins, necessitating a greater total lock length. This number of pins can be accommodated because the flange need not, in some embodiments, extend completely around the housing.

A cylinder lock in accordance with the invention may be formed from any desired suitable material, typically a metal. Brass, e.g. MB1 brass, and stainless steel are examples of suitable materials.

According to a still further aspect the invention provides a cylinder lock whose cylinder is provided with a flange located part way there along, said flange having a first inner face whose periphery is adapted to fit flush against a door or door furniture and a second face which is tapered.

Preferred embodiments of the invention will now be described in greater detail by way of example only, with reference to the accompanying drawings in which:

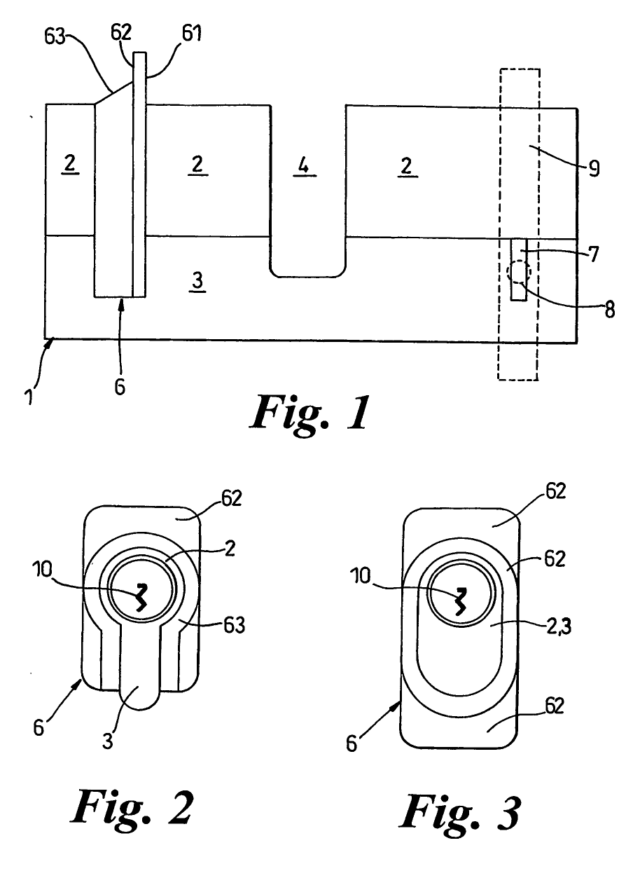

FIG. 1 is a side elevation of a double-cylinder “Euro” lock in accordance with the invention,

FIG. 2 is an end elevation of the lock of FIG. 1,

FIG. 3 is an end elevation of a so-called oval lock, in accordance with a second embodiment of the invention,

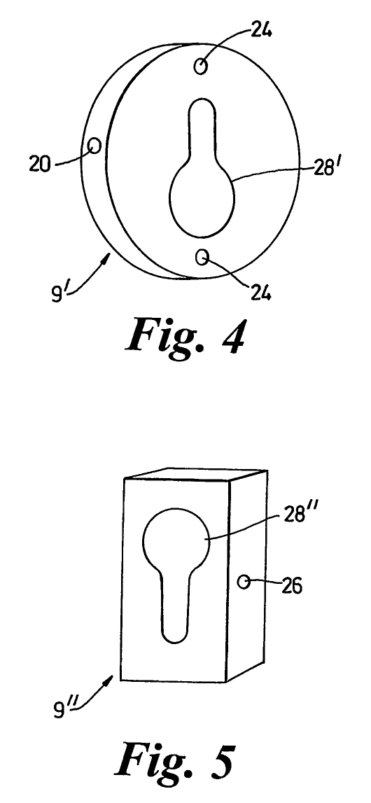

FIG. 4 is a perspective view of a first removable flange, and

FIG. 5 is a perspective view of a second removable flange.

In FIG. 1, a double cylinder lock 1 comprises two integrally joined lock cylinders 2 each including a common locking pin casing portion 3. The cylinders are partially separated by a central gap 4. The locking pin casing 3 is continuous over the length of the lock, though it is notched at the central gap 4.

Towards one end of the lock, intended for mounting at the outdoor or high risk side of a door, is provided a flange 6. This flange 6 is integrally cast with the lock housing, and extends around most, but not all of that housing. The flange 6 has a first, inner face 61 which is flat and adapted to fit flush against a flat door surface. The second, outer face 62 of the flange 6 includes a tapered section 63 leading down to the body 2, 3 of the cylinder lock.

The part of the lock pin casing where the flange 6 does not extend is at the bottom, as seen in FIGS. 1 and 2, of the adjacent locking pin casing portion 3 so that the flange does not interfere with, or limit the number of, holes that can be provided in the pin casing portion for the pins.

Towards the indoor or low risk side of the door, the lock is provided with a groove 7 in its pin casing portion 3 for reception of a fixing grub screw 8 of a demountable flange 9 which extends fully around the casing. The lock may thereby be held securely to a door which is clamped tightly between the flanges 6 and 9.

FIGS. 4 and 5 show alternative demountable flanges 9′ and 9″. Demountable flange 9′ has a generally circular cross-section and comprises a 5 mm hole 20 in a side wall for receiving a fixing grub screw 8. A face 22 of the flange 9′ has countersunk holes 24 for attachment to the door. Demountable flange 9″ comprises a general rectangular profile and has a 5 mm hole 26 in a side wall for receiving a fixing grub screw 8. Both flanges 9, 9″ have key holes 28′, 28″.

FIG. 2 shows an end view of the lock including an opening 10 for the insertion of a key for unlocking it.

FIG. 3 shows an end view of a second embodiment of lock which differs from the foregoing in that the body 2, 3 of the cylinder lock is oval in section rather than keyhole shaped as is the Euro lock of FIGS. 1 and 2, and in that the flange 6 wholly surrounds that body. The same reference numerals are used to denote similar features.

1. A double cylinder lock comprising a first lock cylinder integrally joined to a second lock cylinder, apertures for receiving locking pins being located on a surface of the first lock cylinder, a flange located part way along the first cylinder, said flange having a first, inner face whose periphery is adapted to fit flush against a door or door furniture, or other closure.

2. A cylinder lock according to claim 1, in which the flange extends around part, but not all, of the first lock cylinder.

3. A cylinder lock according to claim 2, in which the apertures are located along a lower surface of the first lock cylinder and the flange does not extend around the lower surface.

4. A cylinder lock according to claim 1, in which the flange comprises a second, outer face which is tapered.

5. A cylinder lock according to claim 1, in which the flange is separate from the lock cylinder.

6. A cylinder lock according to claim 5, in which the lock cylinder is manufactured by extrusion.

7. A cylinder lock according to claim 5, in which the separate flange is secured to the cylinder by pins.

8. A cylinder lock according to claim 5, in which the separate flange is secured to the cylinder by soldering.

9. A cylinder lock according to claim 5, in which the flange is secured between a protrusion on the cylinder and the door or door furniture or other closure.

10. A cylinder lock according to claim 9, in which the protrusion is formed by a stud attached to the cylinder.

11. A cylinder lock according to claim 1, in which the flange is integral with the lock cylinder.

12. A cylinder lock according to claim 11, in which the lock cylinder is formed by investment casting.

13. A cylinder lock according to claim 1, in which a removable flange is provided on the indoor side of the cylinder for securing it in the door or closure.

14. A cylinder lock according to claim 13, in which the removable flange is secured by grub screws or the like, and a recess such as a slot may be provided in the cylinder to receive the tips of such grub screws.

15. A cylinder lock according to claim 1, in which the lock is operable from outdoor and indoor sides of the door or closure and the separately actuable first and second lock cylinders are connected, in a known manner, through a cam to a bolt for locking and releasing the bolt upon actuation of one or other of the cylinders, the cam being located between the cylinders in a gap in a pin casing which connects the cylinders.

16. A cylinder lock according to claim 15, in which in an operative position the cam is fully contained in the gap within the profile of the cross-section of the pin casing.

17. A cylinder lock according to claim 15, in which in its operative position the cam is arranged to project out of the gap by a few degrees to one side or the other of the body.

18. A cylinder lock according to claim 17, in which the cam acts with the integral, or fixed, flange to retain the lock securely in the door.

19. (canceled)
